(19) United States
(12) Patent Application Publication
(10) Pub. No.: US 2026/0340535 A1
(43) Pub. Date: Oct. 29, 2026

(54) GENERATION METHOD, COMPUTER, AND STORAGE MEDIUM

(71) Applicant: Kabushiki Kaisha Toshiba, Kawasaki-shi (JP)

(72) Inventors: Hirotomo OSHIMA, Yokohama Kanagawa (JP); Masamitsu FUKUDA, Yokohama Kanagawa (JP); Yoshiyuki HIRAHARA, Mishima Shizuoka (JP); Ayumu NIINUMA, Chigasaki Kanagawa (JP); Yasuo NAMIOKA, Nerima Tokyo (JP)

(21) Appl. No.: 19/451,456

(22) Filed: Jan. 16, 2026

(30) Foreign Application Priority Data
Mar. 24, 2025 (JP) 2025-047966

(51) Int. Cl. G06Q 10/0631

(52) U.S. Cl. CPC G06Q 10/063118

(57) ABSTRACT

In a generation method according to an embodiment, a production plan is generated by a computer. Master data including processes to be performed in a production, equipment usable in the production, workers available to engage in the production, a duration of each of the processes, working hours for each of the workers, and operation days of a production site is acquired. A first production plan satisfying a constraint condition including a delivery deadline is generated based on the master data. Whether labor conditions of the first production plan satisfy a preset standard is determined. When the labor condition does not satisfy the standard, a new constraint condition is generated by adding possible assignment data to the constraint condition. The possible assignment data includes information of the workers assignable in each time and date. A second production plan satisfying the new constraint condition is generated based on the master data.

### CROSS-REFERENCE TO RELATED APPLICATIONS

This application is based upon and claims the benefit of priority from Japanese Patent Application No. 2025-047966, filed on Mar. 24, 2025; the entire contents of which are incorporated herein by reference.

### FIELD

Embodiments of the invention relate generally to a generation method, a computer, and a storage medium.

### BACKGROUND

A production plan may be generated when producing an article. The production plan is generated to increase efficiency or reduce the time period. It is also desirable to generate the production plan with consideration for worker safety.

### BRIEF DESCRIPTION OF THE DRAWINGS

FIG. 1 is a block diagram showing a configuration of a generation system according to an embodiment;

FIG. 2 is a flowchart showing a generation method according to an embodiment;

FIG. 3 is a table illustrating master data;

FIG. 4 is a table illustrating master data;

FIGS. 5A and 5B are tables illustrating master data;

FIG. 6 is a table illustrating master data;

FIG. 7 is a table illustrating master data;

FIG. 8 is a table illustrating master data;

FIG. 9 is an example of an objective function and constraint conditions for generating a production plan;

FIG. 10 is an example of a first production plan;

FIG. 11 is an example of an objective function and constraint conditions to generate possible assignment data;

FIG. 12 is a table illustrating possible assignment data;

FIG. 13 is a schematic view illustrating a graphical user interface;

FIG. 14 is another example of the objective function and the constraint conditions to generate the production plan; and

FIG. 15 is a schematic view illustrating a hardware configuration.

### DETAILED DESCRIPTION

In a generation method according to an embodiment, a production plan is generated by a computer. The computer is caused to acquire master data including a plurality of processes to be performed in a production, a plurality of equipment usable in the production, a plurality of workers available to engage in the production, a duration of each of the processes, working hours for each of the workers, and operation days of a production site. The computer is caused to generate, based on the master data, a first production plan satisfying a constraint condition including a delivery deadline. The computer is caused to determine whether or not labor conditions of the first production plan satisfy a standard, the standard being preset, the labor conditions including a number of the workers assigned to each of the processes, and a work condition of each of the workers. The computer is caused to, when the labor condition does not satisfy the standard, generate a new constraint condition by adding possible assignment data to the constraint condition. The possible assignment data includes information of the workers assignable in each time and date. The computer is caused to generate a second production plan satisfying the new constraint condition based on the master data.

Embodiments of the invention will now be described with reference to the drawings. In the drawings and the specification of the application, components similar to those described thereinabove are marked with like reference numerals, and a detailed description is omitted as appropriate.

A production plan may be generated when producing an article. The production plan includes an allocation of resources (equipment and personnel) for each process, and is generated to maximize production efficiency and meet the delivery deadline.

In the case of a custom-designed product, many processes are necessary for production, including design, procurement, manufacturing, installation, maintenance, etc. It is therefore common for a production plan to be generated beforehand, and for the production to proceed according to the production plan. Particularly in the case of a large custom-designed product, production may take several years; and a production plan covering a long period is generated. Examples of large custom-designed products include power plants, chemical plants, oil refineries, steel mills, ships, railway cars, etc.

Various types of information are used when generating a production plan. For example, information that is referenced includes processes performed in production, available equipment, the time required for each process, workers available to engage in production, working hours for each worker, etc. The production plan that is generated must consider worker safety. For example, in the production plan, it is necessary for the number of work days of a worker in a prescribed period, the number of consecutive work days, etc., to satisfy standards specified by the corporation or by law. It takes much labor to generate a production plan satisfying safety standards while using various information.

Even after the production plan is generated, various factors may necessitate modifications to the production plan. For example, there may be a requirement from a customer to modify product specifications after starting production. There are cases where a delay in the delivery of a part to be used delays some processes. In such cases, it is necessary to re-generate the production plan.

In particular, the grace period until the product delivery deadline becomes short when delays in production occur. When the production plan is regenerated, worker labor conditions tend to degrade in order to meet the delivery deadline. For example, the number of consecutive work days for workers increases. Worker overtime hours increase. One process is performed by fewer workers. On the other hand, safety standards still must be satisfied in such cases. Therefore, the difficulty of generating the production plan increases as the grace period until delivery deadline decreases.

Embodiments of the invention are used to generate a production plan that satisfies safety standards.

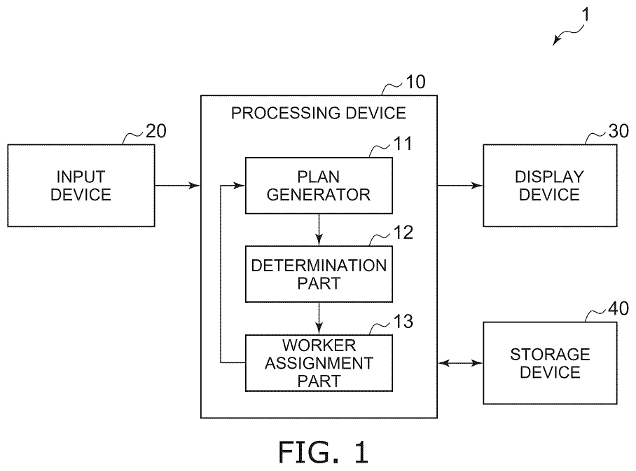

FIG. 1 is a block diagram showing a configuration of a generation system according to an embodiment.

The generation system 1 according to the embodiment includes a computer 10, an input device 20, a display device 30, and a storage device 40. The computer 10 generates a production plan. The input device 20 is used by a user to input data to the computer 10. The display device 30 displays the data output from the computer 10. The storage device 40 stores data necessary to generate the production plan.

The computer 10 functions as a plan generator 11, a determination part 12, and a worker assignment part 13. The plan generator 11 generates the production plan. The plan generator 11 generates the production plan so that the time necessary for production is as short as possible, without considering detailed standards related to safety. Schedulers such as Asprova APS (registered trademark), FLEXSCHE (registered trademark), JoyScheduler (registered trademark), etc., can be utilized to generate the production plan.

The determination part 12 determines whether or not the production plan generated by the plan generator 11 satisfies safety standards. When the production plan does not satisfy the safety standards, the worker assignment part 13 generates worker assignment information to satisfy the safety standards. The plan generator 11 re-generates the production plan by using the worker assignment information.

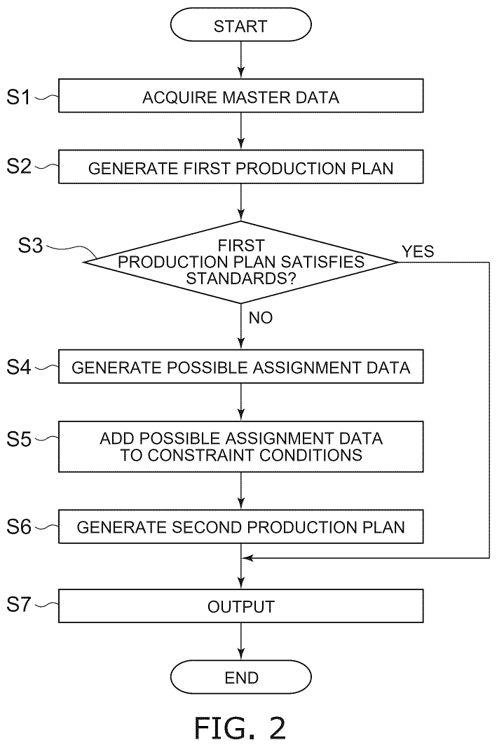

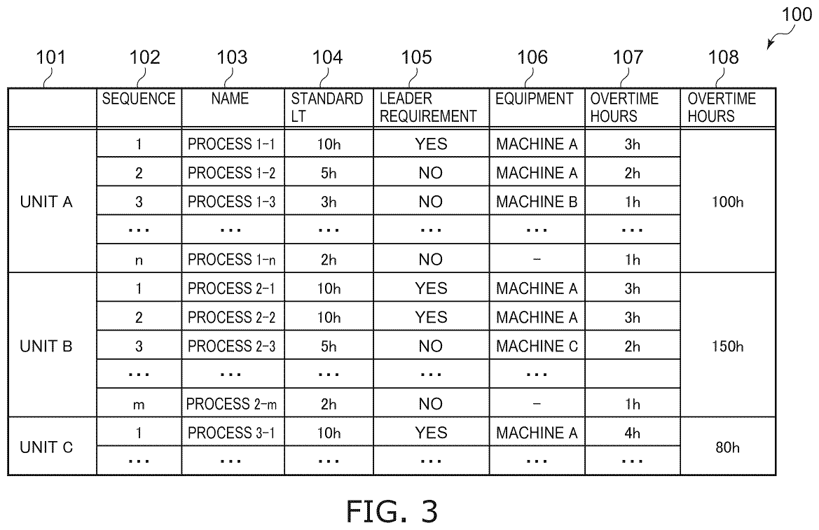

FIG. 2 is a flowchart showing a generation method according to an embodiment. FIGS. 3 to 8 are tables illustrating master data.

A specific generation method of the production plan will now be described. The generation method according to the embodiment is performed by the computer 10. First, the plan generator 11 acquires the master data used to generate the production plan from the storage device 40 (step S1). The master data includes multiple processes performed in production, multiple equipment usable in production, multiple workers available to engage in production, the time required for each process, the working hours of each worker, and the operation days of the production site.

Process master data 100 shown in FIG. 3 includes an object 101, a sequence 102, a name 103, a standard lead time 104, leader requirement information 105, equipment 106, overtime hours 107, and overtime hours 108. The object 101 indicates the object of the work such as a module, a unit, a component, a subassembly, etc. The name 103 indicates the name of the process; and the sequence 102 indicates the execution sequence of the processes. The standard lead time 104 indicates the standard lead time of the process. The leader requirement information 105 indicates whether or not it is necessary to allocate a leader to the process. The equipment 106 indicates the equipment used in the process. Equipment that is indicated by the equipment 106 is essential to the process. The overtime hours 107 indicate the overtime available for each process. The overtime hours 108 indicate the overtime available for each unit.

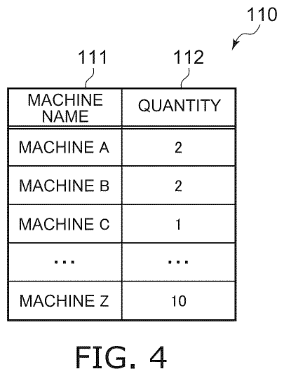

Equipment master data 110 shown in FIG. 4 includes a machine name 111 and a quantity 112 of the machine. Here, the machine that is used in the process is registered as the equipment. Other than a machine, an appliance, an instrument, etc., may be registered as equipment.

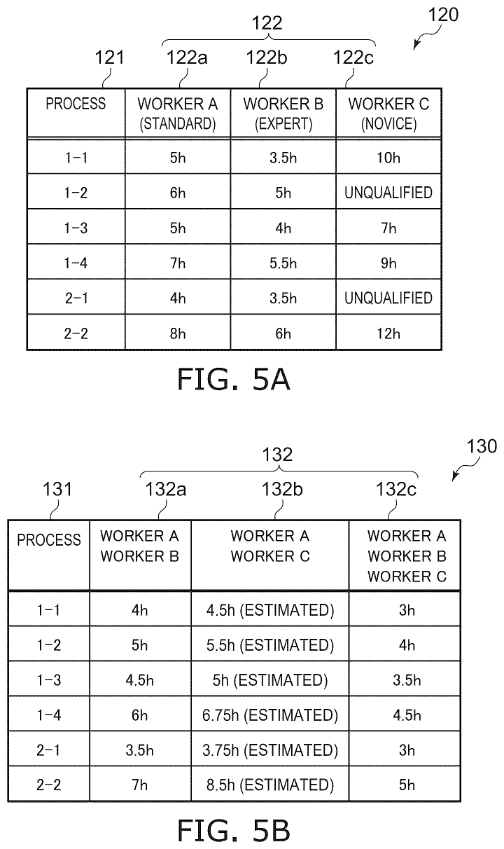

Duration master data 120 shown in FIG. 5A includes a process 121 and a duration 122. The duration master data 120 includes the duration when one worker performs the process. As shown in FIG. 5A, the duration may be registered for each worker. In the illustrated example, durations 122a to 122c are registered. The durations 122a to 122c are respectively the times required by workers A to C. The times required for the processes are different from each other because the workers A to C have different proficiencies. Some processes require sufficient knowledge or a specific qualification. When a worker cannot work in a specific process, such information is registered in the worker master data.

Duration master data 130 shown in FIG. 5B also may be prepared. The duration master data 130 includes a process 131 and a duration 132. The duration master data 130 includes the time required when multiple workers perform the process. As shown in FIG. 5B, the duration may be registered for each combination of workers. In the illustrated example, durations 132a to 132c are registered. The duration 132a is the time required when the workers A and B perform the process. The duration 132b is the time required when the workers A and C perform the process. The duration 132c is the time required when the workers A to C perform the process.

At least a portion of the durations 132a to 132c may be automatically estimated from the duration master data 120 shown in FIG. 5A. In the example shown in FIG. 5B, the duration 132b are automatically estimated. For example, the standard lead time when a standard number of workers performs the process (shown in FIG. 3) and the proficiency of each worker are preregistered. The duration is estimated using the standard lead time and the proficiency of each worker included in the combination. The estimation may be performed using a previous registered calculation formula, or by using a machine-learned model.

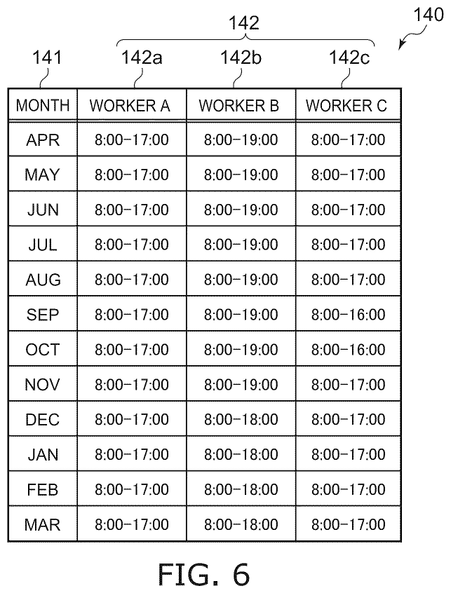

Working hours master data 140 shown in FIG. 6 includes a month 141 and working hours 142a to 142c. The working hours 142a to 142c respectively indicate the time periods that the workers A to C work. In the example shown in FIG. 6, the working hours of each worker are registered for each month. More specifically, the working hours of each worker may be registered for each day.

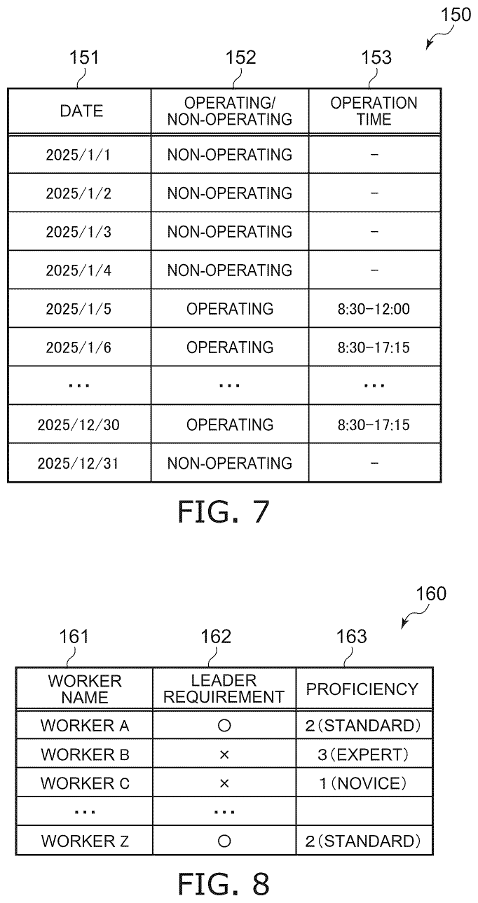

Operation day master data 150 shown in FIG. 7 includes a date 151, an operation status 152, and an operation time 153. The operation status 152 indicates whether or not the production site is operating for each day. For example, a day such as a business holiday or the like on which production at the site is not performed is “non-operating”. The operation time 153 indicates the time period during which production may be performed on an operation day.

The plan generator 11 generates a first production plan by using the master data (step S2 of FIG. 2). For example, the plan generator 11 generates the first production plan by solving the job-shop scheduling problem. In the job-shop scheduling problem, workers and equipment are assigned to each process.

Worker master data 160 shown in FIG. 8 includes a worker name 161, leader capability information 162, and a proficiency 163. The worker name 161 is the name of each worker. Information (an ID, etc.) that identifies each worker may be registered instead of the name. The leader capability information 162 indicates whether or not the worker can be a leader of a process. Whether or not each worker can be a leader may be registered for each process. The proficiency 163 indicates the level of learning of each worker for the work. The proficiency of each worker may be registered for each process.

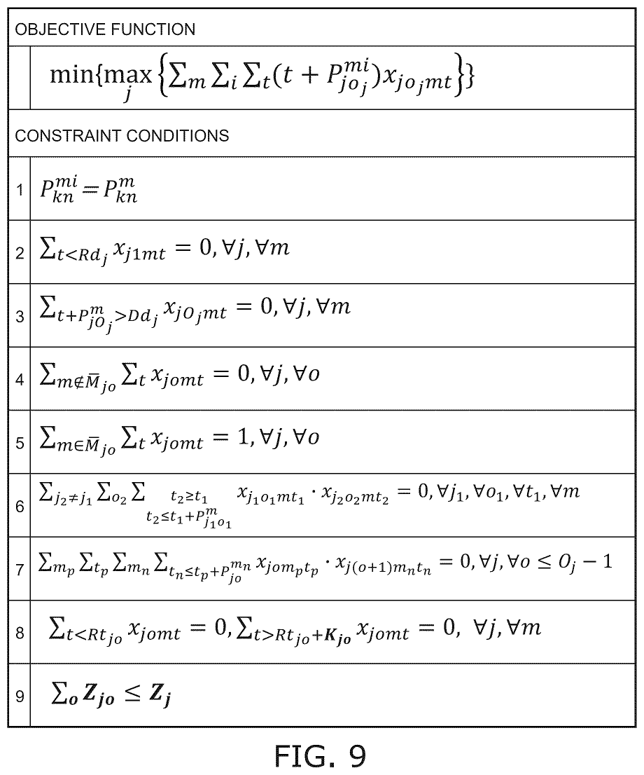

FIG. 9 is an example of an objective function and constraint conditions for generating the production plan.

For example, the objective function and the constraint conditions shown in FIG. 9 are used in the job-shop scheduling problem. In the objective function and the constraint conditions shown in FIG. 9, “J” is the total number of jobs. Here, “job” means the object of the work. “Unit” shown in FIG. 3 is an example of a job. “Oⱼ” is the total number of processes necessary for a job j. “oⱼ” is the oth process of the job j. “P^{mi}ⱼₒⱼ” is the processing time when a worker i (including cases of multiple workers) performs the oth process of the job j with a machine m. Here, “machine” means equipment. “Rdⱼ” is the time when the job j can be started. “Rtⱼₒ” is the time when the oth process of the job j can be started (the shift start time). “Ddⱼ” is the delivery deadline of the job j. “M” is the number of machines. “I” is the number of workers. “Mⱼₒ” is the set of machines that can perform the oth process of the job j. “Zⱼ” is the total available overtime of the job j. “Zⱼₒ” is the available overtime of the oth process of the job j. “Kⱼₒ” is the operation time of the oth process of the job j, and is represented by Kⱼₒ=7.75+Zⱼₒ. Oⱼ, oⱼ, P^{mi}ⱼₒⱼ, Rdⱼ, Rtⱼₒ, Ddⱼ, M, I, Mⱼₒ, Zⱼₒ, Zⱼₒ, and Kⱼₒ are constants set based on the master data.

“xⱼₒⱼₘₜ” is a variable indicating when to start each process. When xⱼₒⱼₘₜ is 1, the oth process of the job j is started at a time t at the machine m. When xⱼₒⱼₘₜ is 0, the oth process of the job j is not started at the time t at the machine m.

In the example shown in FIG. 9, the objective function is directed to reduce the total time required for production. Specifically, according to the objective function shown in FIG. 9, the maximum time after all of the processes have been performed (the time after completion of the final process) is calculated; and the variables are determined to minimize the maximum time.

For the constraint conditions, the first condition indicates that the nth process of the job j is fixed for the constraint of the process execution sequence. Here, the process being fixed means that the date on which the process is to be performed, the workers assigned to the process, and the machine assigned to the process are fixed. The second condition indicates that the first process does not start before the startable period. The third condition indicates that the final process cannot be finished later than the delivery deadline. The fourth condition indicates that the process will not be assigned to a machine that cannot perform the processing. The fifth condition indicates that each process is performed only once. The sixth condition indicates that each machine cannot simultaneously perform two or more processes. The seventh condition indicates that a process may not start before the previous process is completed. The eighth condition indicates that the process is not to be allocated to a time other than the operation time. The ninth condition indicates that the overtime hours upper limit for each job is not to be exceeded.

The first production plan is obtained by solving the job-shop scheduling problem shown in FIG. 9. In the first production plan, each worker is assigned to one of the processes; and the time at which each process is to be performed is determined.

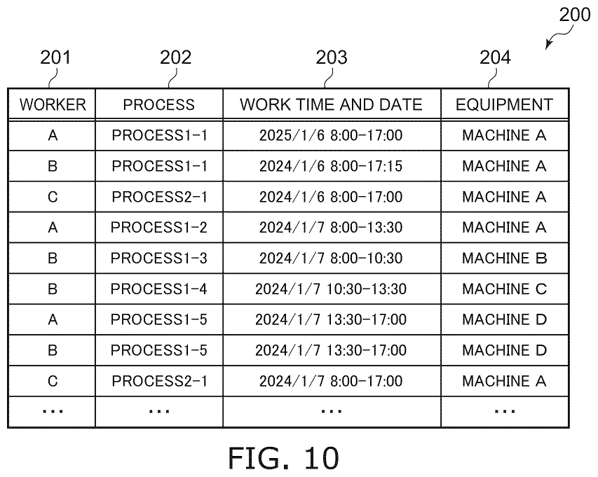

FIG. 10 is an example of a first production plan.

The first production plan 200 shown in FIG. 10 includes a worker 201, a process 202, a time and date 203, and equipment 204. The worker 201 indicates the worker performing the process. The process 202 indicates the process to be performed by the worker. The time and date 203 indicate the time and date the work is to be performed. The equipment 204 indicates the equipment assigned to each process and each time and date.

The determination part 12 determines whether or not the first production plan that is generated satisfies the preset standards for safety (step S3 of FIG. 2). For example, there are legal restrictions on work conditions that consider the safety of persons engaged in labor. Examples of legal restrictions include an upper limit on overtime hours, an upper limit on the number of consecutive work days, etc. There are also cases where corporations set standards that are more stringent than legal restrictions. Also, in the production of a large product, there are cases where a standard number of workers is determined for each process for safety reasons. It is desirable that the number of workers performing the process is not very different from the standard number of workers. For these points, the determination part 12 determines whether or not the labor conditions, including the number of workers for each process and the work conditions of each worker, satisfy the safety standards.

For example, based on the first production plan, the determination part 12 calculates the total overtime for one month for each worker. The determination part 12 calculates the maximum number of consecutive work days for each worker. The determination part 12 calculates the number of workers engaged in each process. The determination part 12 compares this information to the standards. The determination part 12 determines that the first production plan does not satisfy the standards when the total overtime of any worker is greater than the preset upper limit, when the number of consecutive work days of any worker is greater than the preset upper limit, or when the difference between the standard number of workers and the number of workers in any process is greater than the threshold.

When the first production plan is determined not to satisfy the standards, the worker assignment part 13 calculates assignable workers for each time and date and generates possible assignment data (step S4). For example, the worker assignment part 13 generates the possible assignment data by solving the nurse scheduling problem.

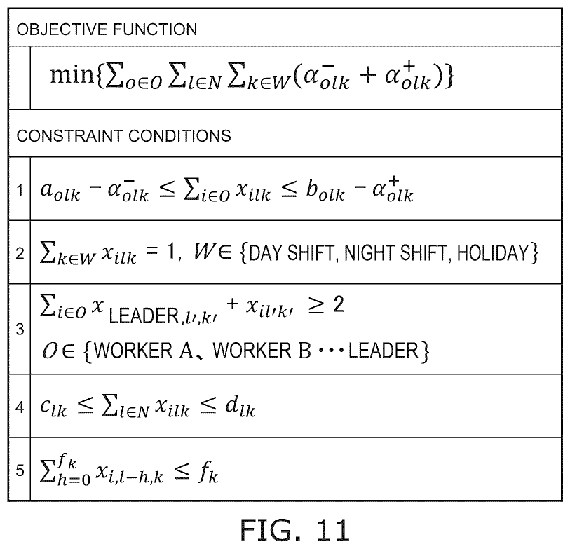

FIG. 11 is an example of the objective function and the constraint conditions to generate the possible assignment data.

In the objective function and the constraint conditions of FIG. 11, “J” is the total number of jobs. “Oⱼ” is the necessary processes of the job j. “oⱼ” is the oth process of the job j. “N” is the period covered by the plan. “W” is the work shift. “aₒₗₖ” is the lower limit of the number of workers assigned to a shift k on a day l for a process o. “bₒₗₖ” is the upper limit of the number of workers assigned to the shift k on the day l for the process o. “cₗₖ” is the minimum number of times (number of days) that each worker can perform each shift k. “dₗₖ” is the maximum number of times (number of days) that each worker can perform each shift k. “fₖ” is the upper limit of the number of consecutive work days when each worker performs each shift k. J, Oⱼ, oⱼ, N, W, aₒₗₖ, bₒₗₖ, cₗₖ, dₗₖ, and fₖ are constants set based on the master data. “α⁺ₒₗₖ” indicates the number of excessive workers on the day l for the oth process. “α⁻ₒₗₖ” indicates the number of insufficient workers on the day l for the oth process. “h” indicates the number of days, and is an integer not less than 0 but less than fₖ.

xᵢₗₖ is a variable indicating whether or not the worker i works in the shift k of the day l. When xᵢₗₖ is 1, the worker i works in the shift k of the day l. When xᵢₗₖ is 0, the worker i does not work in the shift k of the day l.

Among the constraint conditions, the first condition indicates that the number of the workers i working in the shift k of the day l is not less than the lower limit but less than the upper limit. α⁻ₒₗₖ and α⁺ₒₗₖ are omissible from the first constraint condition. However, in such a case, a solution may not be found. In the illustrated example, α⁻ₒₗₖ and α⁺ₒₗₖ are set to relax the constraints of the solution search; and the objective function is set to minimize these variables. The second condition indicates that each worker is assigned to work (in a shift) on some time and date. In other words, the production plan is generated so that each worker registered in the worker master data will work at least once. The third condition is related to work leaders. A work leader is necessary for the shift k′ on the day l′ for the o′th process; and one or more leaders are always assigned to processes that require a leader. The fourth condition indicates that the number of shifts of each worker is within the range of the minimum number of shifts and the maximum number of shifts. The fifth condition indicates that the maximum number of consecutive work days for the same shift is not exceeded by any worker. For example, upper limits of the number of consecutive work days are preset for the day shift and for the night shift. It is specified that the sum of the variable xᵢₗₖ does not exceed fₖ when h is varied from 0 to fₖ (the upper limit of the number of consecutive work days).

According to the objective function and the constraint conditions according to FIG. 11, the assignment of the workers is calculated to minimize the sum of the number of excessive workers and the number of insufficient workers in each process while satisfying the safety standards.

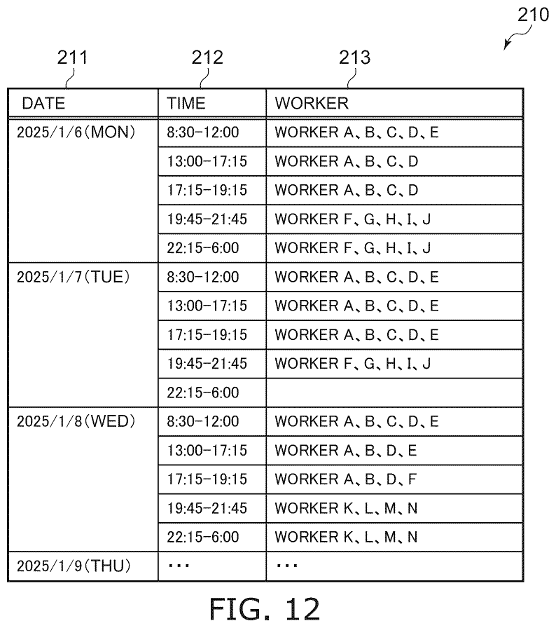

FIG. 12 is a table illustrating possible assignment data.

The possible assignment data 210 shown in FIG. 12 includes information of a date 211, a time 212, and a worker 213. The worker 213 indicates the workers that can work during the time 212 of the date 211 while satisfying the safety standards.

The plan generator 11 adds the generated possible assignment data to the constraint conditions for solving the job-shop scheduling problem (step S5 of FIG. 2). Based on the master data, the plan generator 11 generates a second production plan that satisfies the new constraint conditions to which the possible assignment data is added (step S6).

The second production plan is generated using the constraint conditions (possible assignment data) for satisfying the safety standards. Accordingly, the second production plan that satisfies the safety standards is generated. The plan generator 11 outputs the second production plan (step S7). For example, the plan generator 11 stores the second production plan in a prescribed file format on a storage medium or a server. The plan generator 11 may display the second production plan on the display device 30.

The plan generator 11 outputs a notification if a production plan cannot be generated (the job-shop scheduling problem cannot be solved) in step S2 or S6. In such a case, the user takes action and updates the master data, such as increasing the number of available workers, delaying the delivery deadline of some job, increasing the number of usable machines, etc. Subsequently, the generation method shown in FIG. 2 is re-performed.

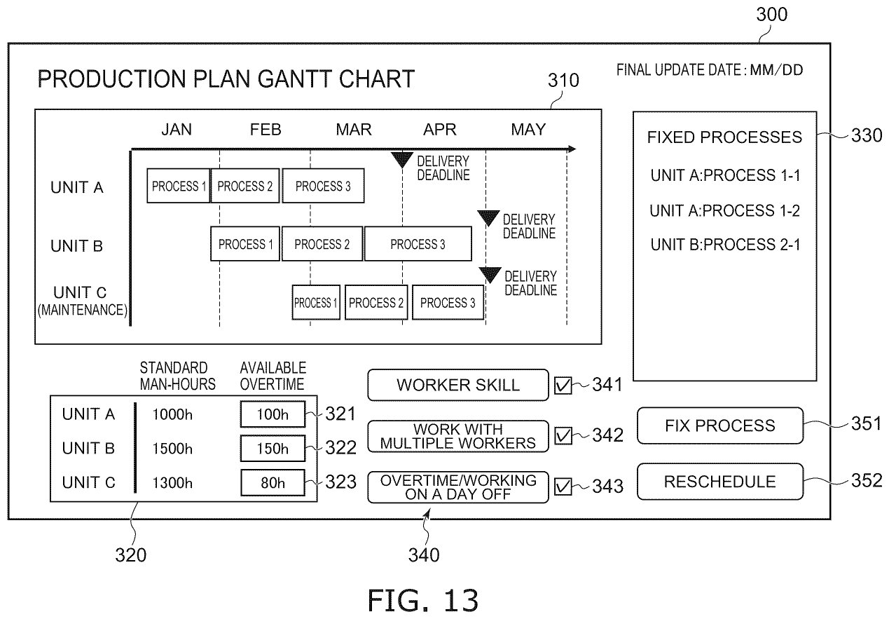

FIG. 13 is a schematic view illustrating a graphical user interface.

After generating the second production plan, for example, the display device 30 displays the graphical user interface (GUI) 300 shown in FIG. 13. The GUI 300 includes a production plan display area 310, a job man-hours display area 320, a fixed process display area 330, a condition setting area 340, an icon 351, and an icon 352.

The production plan display area 310 displays the first production plan or the second production plan generated by the plan generator 11. The display method of the production plan is settable as appropriate. In the illustrated example, the production plan is displayed in a Gantt chart for each job (unit). The production plan may be shown in list form, calendar form, a flowchart, etc., instead of a Gantt chart.

The job man-hours display area 320 displays the standard man-hours and the available overtime for each job. The job man-hours display area 320 includes an input field 321. The user can input the available overtime for each job in the input field 321.

The fixed process display area 330 display fixed processes. When the process is fixed, the date on which the process is performed, the workers assigned to the process, and the equipment assigned to the process are fixed. For example, after a production plan is generated, one of the processes is fixed when generating another production plan by adjusting the master data or the constraint conditions. In such a case, the date, worker, and equipment of the process in the re-generated production plan are unchanged from those of the production plan generated directly-previously.

The condition setting area 340 displays conditions when generating the production plan. The user can set whether or not the conditions displayed in the condition setting area 340 are used to generate the production plan. In the illustrated example, the condition setting area 340 displays checkboxes 341 to 343.

When the skill (the proficiency) of the workers is to be considered when generating the production plan, the user checks the checkbox 341. When the checkbox 341 is checked, the production plan is generated using the preregistered time required by each worker as shown in FIG. 5A. When the checkbox 341 is not checked, the production plan is generated using the preregistered standard duration.

For processes performed by multiple workers, the user checks the checkbox 342 when changes in the duration due to the number of workers and combinations are to be considered. When the checkbox 342 is checked, the production plan is generated using the time required for each combination of preregistered workers as shown in FIG. 5B. When the checkbox 342 is not checked, the production plan is generated using the preregistered standard duration.

The possibility of overtime or working on a day off (working on a holiday) is set in the checkbox 343. When the checkbox 343 is checked, a production plan that includes overtime or working on a day off may be generated. In such a case, the overtime or working on a day off is planned using the available overtime set in the job man-hours display area 320 as the upper limit.

The icon 351 is displayed for the user to set fixed processes. The user can select any process by clicking the process on the production plan display area 310. After selecting the process, the selected process is fixed by clicking the icon 351. The fixed process is displayed in the fixed process display area 330.

The icon 352 is clicked when the computer 10 is to generate a production plan. When the icon 352 is clicked, the computer 10 performs the generation method shown in FIG. 2. The production plan display area 310 displays the generated production plan.

Advantages of embodiments will now be described.

As described above, considerable labor is necessary to generate a production plan while considering safety standards. Schedulers are commercially available to easily generate production plans. A production plan can be automatically generated by executing a scheduler with a computer. However, even when a conventional scheduler is used, it is not easy to generate a desirable production plan that considers safety standards.

For example, a method may be considered in which safety standards are added to constraint conditions when generating the production plan. However, generally, as the number of constraint conditions increases, it becomes more difficult to obtain an optimal production plan within the ranges of the constraint conditions. This is because as the constraint conditions increase, the range of searchable solutions narrows, and the solution tends to fall into a locally optimal solution.

According to embodiments, first, the plan generator 11 generates a first production plan. Safety standards are not considered when generating the first production plan. The first production plan is generated with fewer constraint conditions. It is therefore easier to obtain a more favorable production plan in a range that satisfies the constraint conditions.

Once the first production plan is generated, the determination part 12 determines whether or not the first production plan satisfies the safety standards. When it is determined that the standards are not satisfied, the worker assignment part 13 calculates the assignable workers for each time and date, and generates possible assignment data. In such a case, the possible assignment data is added to the constraint conditions; and the plan generator 11 generates a second production plan that satisfies the new constraint conditions.

Many constraint conditions are considered when generating the second production plan. It is therefore difficult to obtain an optimal production plan. On the other hand, the safety standards are considered when generating the second production plan. Accordingly, the second production plan that is generated satisfies the safety standards.

In other words, according to the embodiments, a more favorable production plan is generated by generating the first production plan; and if the safety standards are not satisfied by the first production plan, a production plan that reliably satisfies the standards is generated by generating the second production plan. According to the embodiments, the likelihood of obtaining a more favorable production plan while satisfying the safety standards can be increased.

For a large made-to-order product, there are cases where the difficulty of work in the processes is high. For a process having high difficulty, the duration greatly varies according to the proficiency of the workers. Differences in the time required by each worker may greatly affect the progress of production. According to the embodiments as shown in FIGS. 5A and 5B, the durations of the processes also can be set for each worker or for each combination of workers. A production plan having high accuracy can be generated by using the durations for each worker or for each combination of workers.

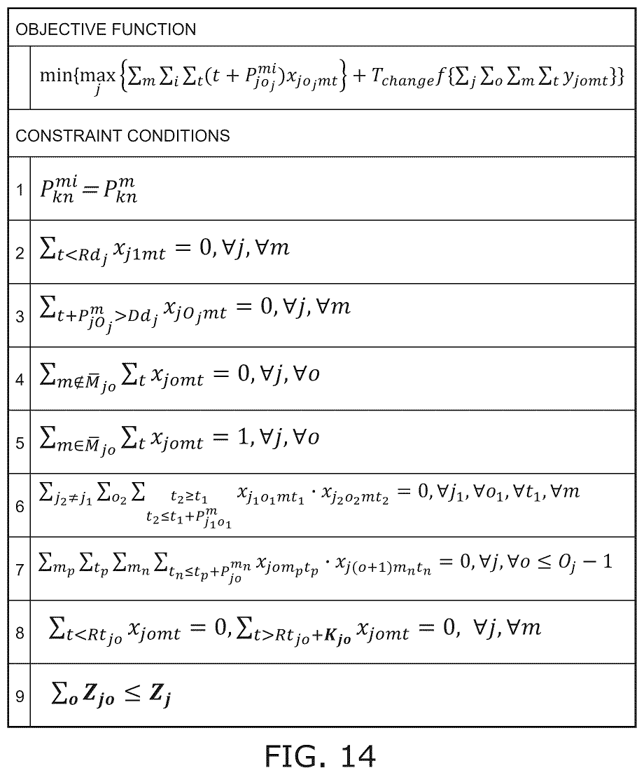

FIG. 14 is another example of the objective function and the constraint conditions to generate the production plan.

The objective function and the constraint conditions shown in FIG. 14 may be used instead of the objective function and the constraint conditions shown in FIG. 9. The objective function and the constraint conditions shown in FIG. 14 are used when a production plan is already generated, and modifications are to be made to the production plan.

Compared to the objective function shown in FIG. 9, a variable is added to the objective function shown in FIG. 14. “yⱼₒₘₜ” represents a schedule modification flag, and indicates that the oth process of the job j to be performed by the machine m at the time t has been modified from the original production plan. Here, “modification” refers to a modification of at least one of a worker, time and date, or machine associated with a process in the original production plan. When yⱼₒₘₜ is “0”, the oth process of the job j performed by the machine m at the time t is not modified from the original production plan. When yⱼₒₘₜ is “1”, the oth process of the job j performed by the machine m at the time t has at least one of a worker, time and date, or machine that is modified from the original production plan. “f” is an initial scheduling flag. f being “0” indicates initial scheduling. “Initial scheduling” refers to a newly-generated schedule. f being “1” indicates rescheduling. “Rescheduling” refers to a schedule generated by adding a modification to an existing schedule. “T_{change}” is a constant set to convert the modification count into time.

When the objective function shown in FIG. 14 is used, the plan generator 11 acquires an existing production plan. The plan generator 11 counts the number of modifications to the existing production plan when generating the first production plan.

In the objective function shown in FIG. 14, the sum of the two terms is minimized. The first term is the total time required for production. In the second term, the number of modifications is multiplied by the coefficient T_{change}. According to the objective function shown in FIG. 14, the sum of the duration of production and the value based on the modification count is minimized. A new production plan that reduces the modifications to the existing production plan while reducing the duration of production is generated.

For example, when modifying the existing production plan, it is necessary to modify the shifts of the workers, move equipment, etc. Shift modifications may be a burden on the workers. Moving equipment may incur costs. Unfavorable effects due to modifications can be suppressed by reducing the modifications to the existing production plan.

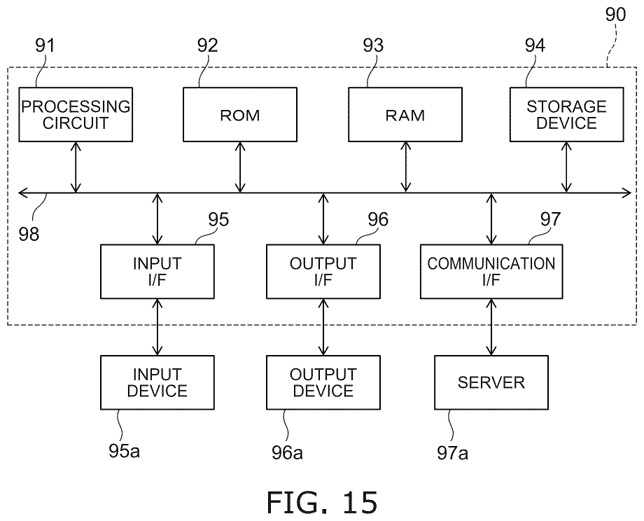

FIG. 15 is a schematic view illustrating a hardware configuration.

For example, a computer 90 shown in FIG. 15 can be used as the computer 10 shown in FIG. 1. The computer 90 includes a processing circuits 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The processing circuit 91 includes an arithmetic processor such as a CPU, a GPU, etc. The processing circuit 91 uses the RAM 93 as work memory to execute the programs stored in at least one of the ROM 92 or the storage device 94. When executing the programs, the processing circuit 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The processing circuit 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The processing circuit 91 can transmit data to the output device 96a via the output I/F 96 and cause the output device 96a to display an image.

The communication interface (I/F) 97 can connect the computer 90 and a server 97a outside the computer 90. The communication I/F 97 is, for example, a network card such as a LAN card, etc. The processing circuit 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing performed by the generation method may be realized by one computer 90, or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, data of a recording medium is read by a computer (or an embedded system). The recording format (the storage format) of the recording medium is arbitrary. For example, the computer reads a program from the recording medium and causes a CPU to execute instructions based on the program. The acquisition (or the reading) of the program by the computer may be performed via a network.

The embodiments of the invention include the following features.

### Feature 1

A generation method of a production plan by a computer, the generation method including:
causing the computer to
   acquire master data including a plurality of processes to be performed in a production, a plurality of equipment usable in the production, a plurality of workers available to engage in the production, a duration of each of the processes, working hours for each of the workers, and operation days of a production site,
   generate, based on the master data, a first production plan satisfying a constraint condition including a delivery deadline,
   determine whether or not labor conditions of the first production plan satisfy a standard, the standard being preset, the labor conditions including
      a number of the workers assigned to each of the processes, and
      a work condition of each of the workers,
   when the labor condition does not satisfy the standard, generate a new constraint condition by adding possible assignment data to the constraint condition, the possible assignment data including information of the workers assignable in each time and date, and
   generate a second production plan satisfying the new constraint condition based on the master data.

### Feature 2

The generation method according to feature 1, in which
the master data includes a time required by one worker for each of the processes, and a time required by a plurality of workers for each of the processes.

### Feature 3

The generation method according to feature 2, in which
the master data includes a time required by each of the workers for each of the processes.

### Feature 4

The generation method according to any one of features 1 to 3, in which
the first production plan and the second production plan are generated to reduce a period of the production.

### Feature 5

The generation method according to feature 4, in which
the computer is configured to acquire an existing production plan, and
the computer is caused to generate the first production plan to reduce a number of modifications of the existing production plan in addition to reducing the period of the production.

### Feature 6

The generation method according to any one of features 1 to 5, in which
the possible assignment data is generated to minimize a sum of excessive workers and insufficient workers in each of the processes.

### Feature 7

The generation method according to any one of features 1 to 6, further including:
causing a display device to display a user interface including the first production plan or the second production plan that is generated.

### Feature 8

A computer configured to perform the generation method according to any one of features 1 to 7.

### Feature 9

A program, when executed by a computer, causing the computer to perform the generation method according to any one of features 1 to 7.

### Feature 10

A storage medium storing the program according to feature 9.

According to the embodiments above, a generation method, a computer, a program, and a storage medium are provided in which the likelihood of obtaining a more favorable production plan can be increased while satisfying safety standards.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A generation method of a production plan by a computer, the generation method comprising:
causing the computer to
acquire master data including a plurality of processes to be performed in a production, a plurality of equipment usable in the production, a plurality of workers available to engage in the production, a duration of each of the processes, working hours for each of the workers, and operation days of a production site,
generate, based on the master data, a first production plan satisfying a constraint condition including a delivery deadline,
determine whether or not labor conditions of the first production plan satisfy a standard, the standard being preset, the labor conditions including
a number of the workers assigned to each of the processes, and
a work condition of each of the workers,
when the labor condition does not satisfy the standard, generate a new constraint condition by adding possible assignment data to the constraint condition, the possible assignment data including information of the workers assignable in each time and date, and
generate a second production plan satisfying the new constraint condition based on the master data.

2. The generation method according to claim 1, wherein
the master data includes a time required by one worker for each of the processes, and a time required by a plurality of workers for each of the processes.

3. The generation method according to claim 2, wherein
the master data includes a time required by each of the workers for each of the processes.

4. The generation method according to claim 1, wherein
the first production plan and the second production plan are generated to reduce a period of the production.

5. The generation method according to claim 4, wherein
the computer is configured to acquire an existing production plan, and
the computer is caused to generate the first production plan to reduce a number of modifications of the existing production plan in addition to reducing the period of the production.

6. The generation method according to claim 1, wherein
the possible assignment data is generated to minimize a sum of excessive workers and insufficient workers in each of the processes.

7. The generation method according to claim 1, further comprising:
causing a display device to display a user interface including the first production plan or the second production plan that is generated.

8. A computer configured to perform the generation method according to claim 1.

9. A storage medium storing a program,
the program, when executed by a computer, causing the computer to perform the generation method according to claim 1.
